(19) United States
(12) Patent Application Publication
(10) Pub. No.: US 2024/0380007 A1
(43) Pub. Date: Nov. 14, 2024

(54) ANTHRAQUINONE COMPOUND-CONTAINING NON-AQUEOUS ELECTROLYTE SOLUTION AND SECONDARY BATTERY INCLUDING THE SAME

(71) Applicant: AIR WATER PERFORMANCE CHEMICAL INC., Kawasaki-shi (JP)

(72) Inventors: Akihiro OKABE, Kawasaki-shi (JP); Daisuke SAKAI, Kawasaki-shi (JP); Ikumi TERAO, Kawasaki-shi (JP)

(73) Assignee: AIR WATER PERFORMANCE CHEMICAL INC., Kawasaki-shi (JP)

(21) Appl. No.: 18/686,760

(22) PCT Filed: May 24, 2022
(86) PCT No.: PCT/JP2022/021229

§ 371 Date: Feb. 26, 2024

(30) Foreign Application Priority Data
Sep. 1, 2021 (JP) 2021-142764

(51) Int. Cl. H01M 10/0567; H01M 4/00; H01M 4/02; H01M 10/0525; H01M 10/0568; H01M 10/0569

(52) U.S. Cl. CPC H01M 10/0567; H01M 4/00; H01M 10/0525; H01M 10/0568; H01M 10/0569; H01M 2004/027; H01M 2004/028; H01M 2300/0037

(57) ABSTRACT

A non-aqueous electrolyte solution composition may allow a high discharge capacity and sufficiently satisfactory cycle characteristics and storage characteristics in lithium ion secondary batteries. A non-aqueous electrolyte solution may include a 4a,9a-dihydroanthraquinone compound of formula (1) or a 4a,9a-dihydromethanoanthraquinone compound of formula (2)

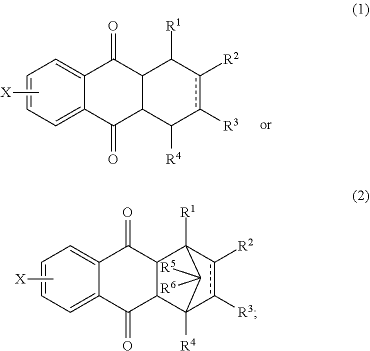

an electrolyte salt; and an organic solvent. In formulas (1) and (2), R¹, R², R³, R⁴, and R⁵ may be identical to or different from one another and be a hydrogen atom, a C₁ to C₁₀ alkyl group, a C₁ to C₁₀ alkenyl group, or a halogen atom, and X is a hydrogen atom, a C₁ to C₁₀ alkyl group, or a halogen atom. A portion in which solid and dashed parallel lines are drawn represents a single bond or a double bond.

### TECHNICAL FIELD

The present invention relates to a non-aqueous electrolyte solution and a secondary battery including the non-aqueous electrolyte solution and, in particular, relates to a non-aqueous electrolyte solution containing a 4a,9a-dihydroanthraquinone compound or a 4a, 9a-dihydromethanoanthraquinone compound and to a secondary battery including the non-aqueous electrolyte solution.

### BACKGROUND ART

In recent years, the energy storage technology has been recognized as one of the important elemental technologies that support the society. In particular, the energy storage technology has a very important status because, in the trend toward renewable energy from resource energy, effective use of natural energy, which has low energy density, is desired. The energy storage technology is represented by secondary batteries and capacitors. Secondary batteries can be charged and discharged by the conversion of chemical energy to electrical energy. Capacitors can be charged and discharged by the physical storage of charge. Currently, among dominating secondary batteries are lithium ion batteries.

Batteries include a positive electrode and a negative electrode, between which ions and electrons move in respective paths. Among batteries are primary batteries, which can only be discharged, and secondary batteries, which can be repeatedly charged and discharged. Secondary batteries can be further classified into two types of batteries according to the reactions involved in the charging and discharging: solution-precipitation-type batteries and intercalation-type batteries. Typical examples of the solution-precipitation-type batteries include lead-acid batteries. Examples of the intercalation-type batteries include lithium ion batteries and nickel metal hydride batteries. The intercalation-type batteries are based on an intercalation reaction, in which ions are inserted into and released from spaces present in the crystals of the materials. Accordingly, active materials in the electrodes can easily retain their shape, and, consequently, a long period of cycle operation can be expected.

Among intercalation-type secondary batteries, most frequently used are lithium ion batteries. Lithium ion batteries are secondary batteries that are charged and discharged by the transfer of lithium ions between the positive electrode and the negative electrode. The charging and discharging is accomplished by the intercalation reaction, in which lithium ions are inserted into and released from spaces present in the crystals of electrode materials. Lithium ion batteries are highly efficient and have characteristics such as light weight, compactness, and a long life. As devices such as smartphones and IoT devices have become increasingly popular, lithium ion batteries are being used widely and have become indispensable in our daily lives. The performance of lithium ion batteries has been dramatically improved, and, accordingly, in recent years, they have begun to be used for energy storage.

Electrolytes that are used in secondary batteries can be classified into aqueous electrolyte solutions, non-aqueous electrolyte solutions, and solid electrolytes. A problem with aqueous electrolyte solutions is that since it is necessary to inhibit electrolysis of water, the operating voltage needs to be low. In contrast, non-aqueous electrolyte solutions are characterized in that they have a high withstand voltage with respect to electrolysis, which enables the operating voltage to be increased. Solid electrolytes are considered to be unlikely to experience side reactions such as electrolysis and be able to withstand a high voltage, compared with electrolyte solutions. However, solid electrolytes present a number of problems, which include inability to be rapidly charged and discharged because of the high resistance encountered in the process of the ion transfer between the solid electrolyte and the electrodes and include changes in volume.

Typically, lithium ion batteries use a non-aqueous electrolyte solution and are made up of a positive electrode, a non-aqueous electrolyte solution, and a negative electrode. The positive electrode primarily uses a lithium-containing transition metal oxide or the like as an active material, and the negative electrode primarily uses a carbon material or the like as an active material. The non-aqueous electrolyte solution used is an organic solvent containing a lithium electrolyte salt dissolved therein. A combination of electrolyte solutions that is widely employed in practical applications is a combination of lithium hexafluorophosphate (LiPF₆) and ethylene carbonate (EC).

The mechanism of the charging and discharging of lithium ion batteries is, for example, as follows. In an instance where the battery is made up of, for example, lithium cobalt oxide, a non-aqueous electrolyte solution, and carbon, the charging is carried out by deintercalating lithium ions from the positive electrode and intercalating the lithium ions into the carbon of the negative electrode. The discharging is carried out by deintercalating the lithium ions from the carbon and intercalating the lithium ions into the oxide of the positive electrode. The charging and discharging is carried out by repeating this process. The carbon of the negative electrode and the lithium cobalt oxide of the positive electrode both have a lamellar structure, in which lithium ions are held in spaces of the crystal structures. Accordingly, even if the charge-discharge reaction is repeated, the positive electrode and the negative electrode can both retain their shape, which is an important factor that makes it possible to repeat the charging and discharging for a long period of time.

During the charging, lithium ions solvated in the electrolyte solution enter the space between the layers of the negative electrode active material, from the interfaces of the negative electrode. The lithium ions at an early stage of the charging are considered to be highly reactive and, thus, react with the carbon electrode, thereby producing an insoluble lithium salt or the like. The product forms a film at the interfaces between the negative electrode active material and the solvated ions. This film is non-electron-conductive and is considered to inactivate the negative electrode active material, thereby inhibiting its exfoliation and the like and, consequently, contributing to stabilization. This film is called a solid electrolyte interphase (SEI). Presumably, after the formation of the SEI, the film serves as an ion tunnel, which inhibits the passage of solvent molecules having a high molecular weight and promotes desolvation of the solvated ions, thereby serving to prevent destruction of the structure of the carbon negative electrode. However, it is generally believed that the formation of the SEI is insufficient, so that repeated charging and discharging may be likely to induce cracking of the active material particles and their exfoliation from a current collector in association with expansion and shrinkage of the negative electrode, and as a result, a rapid operational failure of the battery is likely to occur.

Accordingly, studies have been conducted on various additives for electrolyte solutions, to control the SEI on the surface of the negative electrode. For example, one approach that has been proposed is to add vinylene carbonate (VC) to the electrolyte solution, thereby inhibiting the decomposition of the electrolyte solution (Patent Document 1). Patent Document 1 states that a compound containing at least one unsaturated bond associated with one carbon atom of the cycle is effective and, in an Example, discloses that adding vinylene carbonate to a non-aqueous electrolyte solution formed of propylene carbonate, ethylene carbonate, and dimethyl carbonate inhibits the exfoliation of the carbon of the negative electrode. Furthermore, an additive for an electrolyte solution has been proposed (Patent Document 2). The additive has a controlled potential for undergoing reductive decomposition on a surface of the negative electrode active material, the potential being based on the LUMO of the additive. Patent Document 2 states that adding two types of such additives, in which the LUMO of the additives is controlled, enables the reductive decomposition to occur earlier than the decomposition of the organic solvent, thereby enabling the film to be formed, which means that a hard and stable film can be formed on the surface of the negative electrode active material. Specifically, trimethylsilyl phosphate and lithium tetrafluoroborate (LiBF₄) are cited as examples of a first additive, and vinylene carbonate (VC) and fluoroethyl carbonate (FEC) are cited as examples of a second additive. Unfortunately, in instances where vinylene carbonate is used as an additive, a problem arises in that reaction resistance of the negative electrode significantly increases, which results in a reduction in the input and output of the battery.

Other known examples are ones in which an acrylate compound is added to a non-aqueous electrolyte solution. Patent Document 3 states that using an acrylic monomer as an additive for an electrolyte solution and polymerizing the monomer to form a gel of the electrolyte solution can inhibit gas evolution and degradation of a cathode in a lithium secondary battery. Specifically, dipentaerythritol hexaacrylate is used as the additive. Furthermore, Patent Document 4 states that in instances where an acrylic compound containing three or more acrylic groups is used as an additive for an electrolyte solution of a lithium secondary battery, an SEI is formed through the reductive decomposition reaction at a cathode, and as a result, a decomposition reaction in the electrolyte at the cathode can be inhibited, which, in turn, can improve life characteristics. Specifically, polyacrylate compounds, such as trimethylolpropane triethoxy triacrylate, are disclosed. Furthermore, Patent Document 5 discloses an electrolyte solution containing a saturated chain carboxylic acid ester and an unsaturated carboxylic acid ester. Specifically, the saturated chain carboxylic acid esters disclosed are methyl acetate, methyl propionate, and ethyl propionate, and the unsaturated chain carboxylic acid esters disclosed are vinyl acrylate, methyl acrylate, and ethyl acrylate. According to the disclosure, the addition of vinyl acrylate or the like results in excellent cycle characteristics compared with instances in which vinyl acrylate or the like is not added. Furthermore, Patent Document 6 discloses a lithium secondary battery that uses spinel-type lithium manganese oxide as a positive electrode active material and uses a non-aqueous electrolyte solution containing a compound such as vinyl methacrylate, vinyl acetate, or ethyl acrylate added thereto. According to the disclosure, the addition of the compound results in excellent cycle characteristics and storage characteristics compared with instances in which the compound is not added. Unfortunately, even if any of these acrylic compounds is added, sufficiently satisfactory cycle characteristics and storage characteristics cannot be achieved.

Other known examples are ones in which a compound having a naphthalene skeleton is used as an additive. Patent Document 7 discloses an example in which 2-methoxy naphthalene and a thiophene are used as additives. These additives are added not for the purpose of forming an SEI but for restoring the capacity of the lithium ion battery in instances in which a reduction in the capacity has been detected. Furthermore, a naphthoquinone compound such as 2,3-dichloro-1,4-naphthoquinone is disclosed as an additive that undergoes oxidative decomposition on a surface of a positive electrode earlier than a carbonate-based organic solvent at an early stage of charging to form a film on the surface of the positive electrode (Patent Document 8). Patent Document 8 states that the addition of a naphthoquinone compound produces an effect of inhibiting the oxidative decomposition reaction of the electrolyte on the surface of the positive electrode.

### PRIOR ART DOCUMENTS

### Patent Documents

Patent Document 1: JP-A-8-045545
Patent Document 2: JP-A-2006-12806
Patent Document 3: JP-A-2002-158034
Patent Document 4: JP-A-2003-168479
Patent Document 5: JP-A-2007-335170
Patent Document 6: JP-A-2000-223154
Patent Document 7: JP-A-2020-102348
Patent Document 8: JP-A-2005-108439

### DISCLOSURE OF INVENTION

### Technical Problem

An object of the present invention is to provide a non-aqueous electrolyte solution composition that is for use in a non-aqueous electrolyte solution for lithium ion secondary batteries and enables a high discharge capacity and sufficiently satisfactory cycle characteristics and storage characteristics to be achieved in lithium ion secondary batteries that use the non-aqueous electrolyte solution.

### Solution to Problem

The present inventors diligently conducted studies on fused polycyclic compounds and, consequently, discovered that adding an anthraquinone compound having a specific structure to a non-aqueous electrolyte solution improves the cycle characteristics of lithium ion secondary batteries that use the non-aqueous electrolyte solution. Accordingly, the present invention was completed.

A first aspect of the invention is a non-aqueous electrolyte solution comprising a 4a,9a-dihydroanthraquinone compound represented by general formula (1) or a 4a,9a-dihydromethanoanthraquinone compound represented by general formula (2); an electrolyte salt; and an organic solvent.

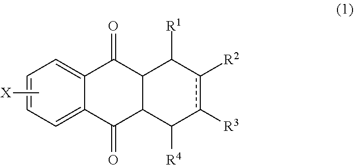

In general formula (1), R¹, R², R³, and R⁴ are identical to or different from one another and each represents a hydrogen atom, a C₁ to C₁₀ alkyl group, a C₁ to C₁₀ alkenyl group, or a halogen atom, and X represents a hydrogen atom, a C₁ to C₁₀ alkyl group, or a halogen atom. A portion in which solid and dashed parallel lines are drawn represents a single bond or a double bond.

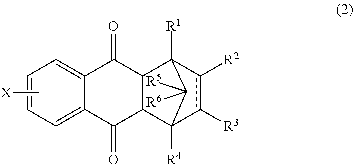

In general formula (2), R¹, R², R³, R⁴, R⁵, and R⁶ are identical to or different from one another and each represents a hydrogen atom, a C₁ to C₁₀ alkyl group, a C₁ to C₁₀ alkenyl group, or a halogen atom, and X represents a hydrogen atom, a C₁ to C₁₀ alkyl group, or a halogen atom. A portion in which solid and dashed parallel lines are drawn represents a single bond or a double bond.

In a second aspect of the invention, the non-aqueous electrolyte solution according to the first aspect of the invention is one in which the organic solvent is at least one member selected from the group consisting of cyclic carbonates, chain carbonates, aliphatic carboxylic acid esters, lactones, lactams, cyclic ethers, chain ethers, sulfones, and halogen derivatives thereof.

In a third aspect of the invention, the non-aqueous electrolyte solution according to the first or second aspect of the invention is one in which the electrolyte salt is a lithium salt.

A fourth aspect of the invention is an energy storage device comprising the non-aqueous electrolyte solution as defined in any one of the first to third aspects of the invention; a positive electrode; and a negative electrode.

In a fifth aspect of the invention, the energy storage device according to the fourth aspect of the invention is one in which the energy storage device is a lithium ion battery.

In the present invention, the numbering of carbon atoms that shows the position of a substituent in the anthraquinone ring and the methanoanthraquinone ring is as follows.

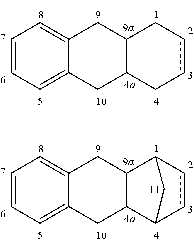

### Advantageous Effects of Invention

Using the non-aqueous electrolyte solution containing a 4a,9a-dihydroanthraquinone compound or a 4a, 9a-dihydromethanoanthraquinone compound of the present invention added thereto enables the production of an energy storage device having a high initial capacity, good cycle characteristics, and good rate characteristics, with the cycle characteristics including a capacity retention rate.

Objects, features, and advantages of the present invention will be made more apparent by the following detailed description.

### BRIEF DESCRIPTION OF DRAWINGS

FIG. 1 is a graph in which a discharge capacity retention rate of coin-cell-type lithium ion secondary batteries is plotted on the vertical axis, and a discharge capacity cycle number of the batteries on the horizontal axis; some of the batteries include a non-aqueous electrolyte solution containing a 4a,9a-dihydroanthraquinone compound or a 1,4,4a, 9a-methanoanthraquinone compound of the present invention, and the other includes a non-aqueous electrolyte solution containing neither of the compounds.

FIG. 2 is a graph in which a discharge capacity retention rate of coin-cell-type lithium ion secondary batteries is plotted on the vertical axis, and a discharge capacity cycle number of the batteries on the horizontal axis; one of the batteries includes a non-aqueous electrolyte solution containing a 4a,9a-dihydroanthraquinone compound or a 4a, 9a-dihydromethanoanthraquinone compound of the present invention, and the others include a non-aqueous electrolyte solution containing a known SEI film forming additive.

### DESCRIPTION OF EMBODIMENTS

The present invention provides a non-aqueous electrolyte solution comprising a 4a, 9a-dihydroanthraquinone compound represented by general formula (1) or a 4a,9a-dihydromethanoanthraquinone compound, an electrolyte salt and an organic solvent.

(4a, 9a-Dihydroanthraquinone Compound and 4a,9a-Dihydromethanoanthraquinone Compound)

4a, 9a-Dihydroanthraquinone compounds of the present invention are compounds having a structure described in general formula (1).

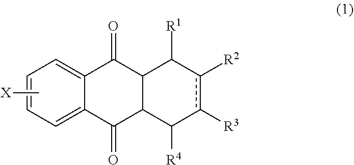

In general formula (1), R¹, R², R³, and R⁴ are identical to or different from one another and each represents a hydrogen atom, a C₁ to C₁₀ alkyl group, a C₁ to C₁₀ alkenyl group, or a halogen atom, and X represents a hydrogen atom, a C₁ to C₁₀ alkyl group, or a halogen atom. The portion in which solid and dashed parallel lines are drawn represents a single bond or a double bond.

4a, 9a-Dihydromethanoanthraquinone compounds of the present invention are compounds having a structure described in general formula (2).

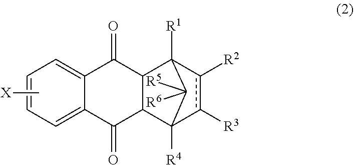

In general formula (2), R¹, R², R³, R⁴, R⁵, and R⁶ are identical to or different from one another and each represents a hydrogen atom, a C₁ to C₁₀ alkyl group, a C₁ to C₁₀ alkenyl group, or a halogen atom, and X represents a hydrogen atom, a C₁ to C₁₀ alkyl group, or a halogen atom. The portion in which solid and dashed parallel lines are drawn represents a single bond or a double bond.

Regarding R¹, R², R³, and R⁴ in general formula (1) and general formula (2) and R⁵ and R⁶ in general formula (2), examples of the C₁ to C₁₀ alkyl group include methyl groups, ethyl groups, n-propyl groups, i-propyl groups, n-butyl groups, i-butyl groups, s-butyl groups, n-pentyl groups, i-amyl groups, n-hexyl groups, n-heptyl groups, n-octyl groups, 2-ethylhexyl groups, decyl groups, and dodecyl groups, and examples of the C₁ to C₁₀ alkenyl groups include those that correspond to any of the mentioned alkyl groups and in which a CH═CH structure is present instead of one or more CH2-CH2 structures present in the alkyl group. More specific examples include vinyl groups, allyl groups, 1-propenyl groups, isopropenyl groups, 2-butenyl groups, 2-methyl-1-propenyl groups, 2-pentenyl groups, 2-methyl-2-butenyl groups, 2-hexenyl groups, cyclopentenyl groups, and cyclohexenyl groups. Examples of the halogen atom include fluorine atoms, chlorine atoms, bromine atoms, and iodine atoms.

Regarding X in general formula (1) and general formula (2), examples of the C₁ to C₁₀ alkyl group include methyl groups, ethyl groups, n-propyl groups, i-propyl groups, n-butyl groups, i-butyl groups, s-butyl groups, n-pentyl groups, i-amyl groups, n-hexyl groups, n-heptyl groups, n-octyl groups, 2-ethylhexyl groups, decyl groups, and dodecyl groups, and examples of the halogen atom include fluorine atoms, chlorine atoms, bromine atoms, and iodine atoms.

Specific examples of 4a, 9a-dihydroanthraquinone compounds represented by general formula (1) and having a double bond in the portion in which solid and dashed parallel lines are drawn include the following compounds. One example is 1,4,4a,9a-tetrahydroanthraquinone, and examples thereof include those in which R¹, R², R³, and/or R⁴ are alkyl groups, such as 2-methyl-1,4,4a,9a-tetrahydroanthraquinone, 1-methyl-1,4,4a, 9a-tetrahydroanthraquinone, 2-ethyl-1,4,4a,9a-tetrahydroanthraquinone, 2-butyl-1,4,4a,9a-tetrahydroanthraquinone, 2-amyl-1,4,4a,9a-tetrahydroanthraquinone, 1,3-dimethyl-1,4,4a, 9a-tetrahydroanthraquinone, 2,3-dimethyl-1,4,4a,9a-tetrahydroanthraquinone, and 1,4-dimethyl-1,4,4a, 9a-tetrahydroanthraquinone. Other examples include those in which R¹, R², R³, and/or R⁴ are halogen atoms, such as 2-chloro-1,4,4a,9a-tetrahydroanthraquinone, and 2-bromo-1,4,4a,9a-tetrahydroanthraquinone.

Specific examples of 4a, 9a-dihydroanthraquinone compounds represented by general formula (1) and having a single bond in the portion in which solid and dashed parallel lines are drawn include the following compounds. One example is 1,2,3,4,4a, 9a-hexahydroanthraquinone, and examples thereof include those in which R¹, R², R³, and/or R⁴ are alkyl groups, such as 2-methyl-1,2,3,4,4a,9a-hexahydroanthraquinone, 1-methyl-1,2,3,4,4a,9a-hexahydroanthraquinone, 2-ethyl-1,2,3,4,4a, 9a-hexahydroanthraquinone, 2-butyl-1,2,3,4,4a,9a-hexahydroanthraquinone, 2-amyl-1,2,3,4,4a, 9a-hexahydroanthraquinone, 1,3-dimethyl-1,2,3,4,4a,9a-hexahydroanthraquinone, 2,3-dimethyl-1,2,3,4,4a,9a-hexahydroanthraquinone, and 1,4-dimethyl-1,2,3,4,4a, 9a-hexahydroanthraquinone. Other examples include those in which R¹, R², R³, and/or R⁴ are halogen atoms, such as 2-chloro-1,2,3,4,4a,9a-hexahydroanthraquinone and 2-bromo-1,2,3,4,4a, 9a-hexahydroanthraquinone.

Other examples include those in which X is an alkyl group, such as 6-methyl-1,4,4a, 9a-tetrahydroanthraquinone, 2,6-dimethyl-1,4,4a,9a-tetrahydroanthraquinone, 2,7-dimethyl-1,4,4a, 9a-tetrahydroanthraquinone, 2-ethyl-6-methyl-1,4,4a,9a-tetrahydroanthraquinone, 2-butyl-6-methyl-1,4,4a,9a-tetrahydroanthraquinone, 2-amyl-6-methyl-1,4,4a,9a-tetrahydroanthraquinone, 2-chloro-6-methyl-1,4,4a,9a-tetrahydroanthraquinone, 2-bromo-6-methyl-1,4,4a, 9a-tetrahydroanthraquinone, 6-methyl-1,2,3,4,4a,9a-hexahydroanthraquinone, 2,6-dimethyl-1,2,3,4,4a,9a-hexahydroanthraquinone, 2,7-dimethyl-1,2,3,4,4a,9a-hexahydroanthraquinone, 2-ethyl-6-methyl-1,2,3,4,4a, 9a-hexahydroanthraquinone, 2-butyl-6-methyl-1,2,3,4,4a,9a-hexahydroanthraquinone, 2-amyl-6-methyl-1,2,3,4,4a,9a-hexahydroanthraquinone, 2-chloro-6-methyl-1,2,3,4,4a,9a-hexahydroanthraquinone, and 2-bromo-6-methyl-1,2,3,4,4a,9a-hexahydroanthraquinone.

Other examples include those in which X is a halogen atom, such as 6-chloro-1,4,4a, 9a-tetrahydroanthraquinone, 2-methyl-6-chloro-1,4,4a,9a-tetrahydroanthraquinone, 2-ethyl-6-chloro-1,4,4a, 9a-tetrahydroanthraquinone, 2-butyl-6-chloro-1,4,4a, 9a-tetrahydroanthraquinone, 2-amyl-6-chloro-1,4,4a,9a-tetrahydroanthraquinone, 2,6-dichloro-1,4,4a, 9a-tetrahydroanthraquinone, 2-bromo-6-chloro-1,4,4a, 9a-tetrahydroanthraquinone, 6-chloro-1,2,3,4,4a,9a-hexahydroanthraquinone, 2-methyl-6-chloro-1,2,3,4,4a, 9a-hexahydroanthraquinone, 2-ethyl-6-chloro-1,2,3,4,4a,9a-hexahydroanthraquinone, 2-butyl-6-chloro-1,2,3,4,4a,9a-hexahydroanthraquinone, 2-amyl-6-chloro-1,2,3,4,4a,9a-hexahydroanthraquinone, 2,6-dichloro-1,2,3,4,4a, 9a-hexahydroanthraquinone, and 2-bromo-6-chloro-1,2,3,4,4a,9a-hexahydroanthraquinone.

Other examples include those in which R¹, R², R³, and/or R⁴ are alkenyl groups, such as 1-(2-methyl-2-butenyl)-3-methyl-1,4,4a,9a-tetrahydroanthraquinone, 1-(3-butenyl)-1,4,4a,9a-tetrahydroanthraquinone, 2-(4-methyl-3-pentenyl)-1,4,4a,9a-tetrahydroanthraquinone, and 1-(2-methyl-1-propenyl)-3,4-dimethyl-1,4,4a,9a-tetrahydroanthraquinone.

Examples other than the above-mentioned compounds include Diels-Alder reaction products of a 1,4-naphthoquinone compound with a compound having a 1,3-diene structure.

Examples of 4a, 9a-dihydromethanoanthraquinone compounds represented by general formula (2) that are Diels-Alder reaction products of a 1,4-naphthoquinone compound with a compound having a cyclopentadiene structure and have a double bond in the portion in which solid and dashed parallel lines are drawn include 1,4,4a,9a-tetrahydromethanoanthraquinone, 1-methyl-1,4,4a,9a-tetrahydromethanoanthraquinone, 2-methyl-1,4,4a,9a-tetrahydromethanoanthraquinone, 11-methyl-1,4,4a,9a-tetrahydromethanoanthraquinone, 11,11-dimethyl-1,4,4a,9a-tetrahydromethanoanthraquinone, 1,2,3,4,11-pentamethyl-1,4,4a,9a-tetrahydromethanoanthraquinone, 6-methyl-1,4,4a,9a-tetrahydromethanoanthraquinone, 6-ethyl-1,4,4a, 9a-tetrahydromethanoanthraquinone, 1,6-dimethyl-1,4,4a, 9a-tetrahydromethanoanthraquinone, 2,6-dimethyl-1,4,4a,9a-tetrahydromethanoanthraquinone, 6,11-dimethyl-1,4,4a,9a-tetrahydromethanoanthraquinone, 6,11,11-trimethyl-1,4,4a, 9a-tetrahydromethanoanthraquinone, 6-chloro-1,4,4a,9a-tetrahydromethanoanthraquinone, and 6-bromo-1,4,4a,9a-tetrahydromethanoanthraquinone.

Examples of those that have a single bond in the portion in which solid and dashed parallel lines are drawn include 1,2,3,4,4a,9a-hexahydromethanoanthraquinone, 1-methyl-1,2,3,4,4a,9a-hexahydromethanoanthraquinone, 2-methyl-1,2,3,4,4a,9a-hexahydromethanoanthraquinone, 11-methyl-1,2,3,4,4a,9a-hexahydromethanoanthraquinone, 11,11-dimethyl-1,2,3,4,4a,9a-hexahydromethanoanthraquinone, 1,2,3,4,11-pentamethyl-1,2,3,4,4a,9a-hexahydromethanoanthraquinone, 6-methyl-1,2,3,4,4a,9a-hexahydromethanoanthraquinone, 6-ethyl-1,2,3,4,4a,9a-hexahydromethanoanthraquinone, 1,6-dimethyl-1,2,3,4,4a,9a-hexahydromethanoanthraquinone, 2,6-dimethyl-1,2,3,4,4a,9a-hexahydromethanoanthraquinone, 6,11-dimethyl-1,2,3,4,4a,9a-hexahydromethanoanthraquinone, 6,11,11-trimethyl-1,2,3,4,4a,9a-hexahydromethanoanthraquinone, 6-chloro-1,2,3,4,4a,9a-hexahydromethanoanthraquinone, and 6-bromo-1,2,3,4,4a,9a-hexahydromethanoanthraquinone.

Among these compounds, 1,4,4a, 9a-tetrahydroanthraquinone (THAQ), 2-(4-methyl-3-pentenyl)-1,4,4a, 9a-tetrahydroanthraquinone (IHETHAQ), 1,4,4a,9a-tetrahydromethanoanthraquinone (CPNQ), 2-methyl-1,4,4a, 9a-tetrahydroanthraquinone (MeTHAQ), and 1,2,3,4,4a,9a-hexahydrohexahydromethanoanthraquinone (NBNQ), which are compounds of the following structural formulae, are preferable because these compounds can be readily synthesized and have a superior effect.

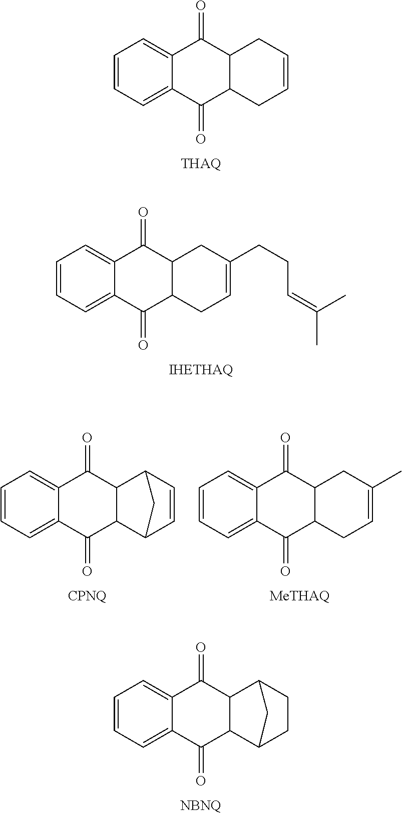

### [Production Method]

Now, synthesis of these compounds will be described in detail. 4a,9a-Dihydroanthraquinone compounds of the present invention can be prepared by using a Diels-Alder reaction of a corresponding 1,4-naphthoquinone compound with a corresponding 1,3-diene compound. 1,4,4a,9a-Tetrahydroanthraquinone (THAQ) can be produced by using a butadiene as the 1,3-diene compound. Thus, 1,4,4a,9a-tetrahydroanthraquinone compounds with various substituents can be prepared by using substituted butadienes. Examples of the substituted butadienes include 2-methyl-1,3-butadiene, 1-methyl-1,3-butadiene, 2,3-dimethyl-1,3-butadiene, myrcene, alloocimene, and chloroprene. Furthermore, 1,2,3,4,4a,9a-hexahydroanthraquinone compounds can be prepared by hydrogenating the prepared 1,4,4a,9a-tetrahydroanthraquinone compounds.

Furthermore, 1,4,4a,9a-tetrahydromethanoanthraquinone (CPNQ) can be produced by using a cyclopentadiene. Furthermore, various 1,4,4a,9a-tetrahydromethanoanthraquinone compounds can be prepared by using a cyclopentadiene compound having a substituent. Examples of the cyclopentadiene compound having a substituent include methylcyclopentadiene, 1,2-dimethylcyclopentadiene, 1,2,3-trimethylcyclopentadiene, 1,2,4-trimethylcyclopentadiene, 1,2,3,4-tetramethylcyclopentadiene, 1,2,3,4,5-pentamethylcyclopentadiene, 1,2,3,4,5-pentachlorocyclopentadiene, tert-butylcyclopentadiene, ethylcyclopentadiene, 5,5-dimethyl-1,3-cyclopentadiene, phenylcyclopentadiene, trimethylsilylcyclopentadiene, 1,2-dimethyl-4-ethylcyclopentadiene, 1,2-dimethyl-4-tert-butylcyclopentadiene, and 1,2-dimethyl-4-trimethylsilylcyclopentadiene. Furthermore, 1,2,3,4,4a,9a-hexahydromethanoanthraquinone compounds can be prepared by hydrogenating the prepared 1,4,4a,9a-tetrahydromethanoanthraquinone compounds.

The 1,4-naphthoquinone compound that is the other of the raw materials may also be any of a variety of compounds. Examples thereof include 1,4-naphthoquinone, 6-methyl-1,4-naphthoquinone, 6-ethyl-1,4-naphthoquinone, 6-chloro-1,4-naphthoquinone, and 6-bromo-1,4-naphthoquinone.

The 4a, 9a-dihydroanthraquinone compound and the 4a,9a-dihydromethanoanthraquinone compound can be produced by heating a 1,3-diene compound and a 1,4-naphthoquinone compound in the presence or absence of a solvent. In Diels-Alder reactions, typically, it is possible to use a Lewis acid catalyst, such as boron trifluoride, to increase the reaction rate. Examples of the catalyst include boron trifluoride ether complexes, aluminum trichloride, and titanium tetrachloride. A reaction temperature is preferably 20° C. or greater and 150° C. or less and more preferably 50° C. or greater and 120° C. or less.

### [Non-Aqueous Electrolyte Solution]

The non-aqueous electrolyte solution of the present invention comprises an organic solvent, an electrolyte salt, and a 4a, 9a-dihydroanthraquinone compound or a 4a,9a-dihydromethanoanthraquinone compound used as an additive.

### (Organic Solvent)

The organic solvent may be an aprotic solvent, which is preferable from the standpoint of, for example, inhibiting an increase in viscosity of the resulting non-aqueous electrolyte solution. In particular, it is preferable that at least one member selected from the group consisting of cyclic carbonates, chain carbonates, aliphatic carboxylic acid esters, lactones, lactams, cyclic ethers, chain ethers, sulfones, and halogen derivatives thereof be included. In particular, a cyclic carbonate or a chain carbonate is more preferably used.

Examples of the cyclic carbonates include ethylene carbonate (EC), propylene carbonate, and butylene carbonate. Examples of the chain carbonates include dimethyl carbonate, diethyl carbonate (DEC), and ethyl methyl carbonate. Examples of the aliphatic carboxylic acid esters include methyl acetate, ethyl acetate, methyl propionate, ethyl propionate, methyl butyrate, methyl isobutyrate, and methyl trimethylacetate. Examples of the lactone include γ-butyrolactone. Examples of the lactams include &-caprolactam and N-methylpyrrolidone. Examples of the cyclic ethers include tetrahydrofuran, 2-methyltetrahydrofuran, tetrahydropyran, and 1,3-dioxolane. Examples of the chain ethers include 1,2-diethoxyethane and ethoxymethoxyethane. Examples of the sulfones include sulfolanes. Examples of the halogen derivatives include 4-fluoro-1,3-dioxolan-2-one, 4-chloro-1,3-dioxolan-2-one, and 4,5-difluoro-1,3-dioxolan-2-one. These organic solvents may be used alone or in a combination of two or more. Examples of the combination include a combination of ethylene carbonate (EC) and diethyl carbonate (DEC). It is also preferable to use a cyclic carbonate and a chain ether in combination.

### (Electrolyte Salt)

Preferably, the electrolyte salt is a lithium salt that serves as an ion source of lithium ions. In particular, the electrolyte salt is preferably at least one member selected from the group consisting of LiAlCl₄, LiBF₄, LiPF₆, LiClO₄, LiAsF₆, and LiSbF₆. In particular, LiBF₄ and LiPF₆ are more preferable because, for example, these salts have a high degree of dissociation and, therefore, can increase the ionic conductivity of the electrolyte solution, and in addition, these salts are oxidation-and-reduction resistant and, therefore, have an effect of inhibiting performance degradation of energy storage devices due to a long period of use. These electrolytes may be used alone or in a combination of two or more.

In the non-aqueous electrolyte solution of the present invention, a concentration of the electrolyte salt is preferably at least 0.1 mol/L and at most 2.0 mol/L. If the concentration of the electrolyte salt is less than 0.1 mol/L, a conductivity and the like of the non-aqueous electrolyte solution cannot be sufficiently ensured, and, therefore, in instances where the non-aqueous electrolyte solution is used in an energy storage device, discharge characteristics, charge characteristics, and the like may be impaired. If the concentration of the electrolyte salt is greater than 2.0 mol/L, a conductivity and the like of the non-aqueous electrolyte solution cannot be sufficiently ensured because an increase in viscosity makes it impossible to sufficiently ensure ion mobility, and, therefore, in instances where the non-aqueous electrolyte solution is used in an energy storage device, discharge characteristics, charge characteristics, and the like may be impaired.

(4a, 9a-Dihydroanthraquinone Compound and 4a, 9a-Dihydromethanoanthraquinone Compound Used as Additives)

The non-aqueous electrolyte solution of the present invention includes a 4a, 9a-dihydroanthraquinone compound or a 4a, 9a-dihydromethanoanthraquinone compound used as an additive. An amount of the addition is not particularly limited, and an optimal amount of the addition varies depending on, for example, the type and compounding ratio of the active materials, a conductive additive, and the like of the electrodes and a composition of the electrolyte solution. Under typical conditions, the amount is preferably 0.005 or greater and less than 1.0 parts by weight and more preferably 0.01 or greater and 0.4 or less parts by weight, per 100 parts by weight of the non-aqueous electrolyte solution. If the amount is less than 0.005 parts by weight, the addition does not produce a significant effect. If the amount is 1.0 parts by weight or greater, oxidative decomposition occurs at the positive electrode side, and, therefore, such an amount is not preferable.

### [Energy Storage Device]

An energy storage device of the present invention includes a positive electrode plate and a negative electrode plate. The positive electrode plate is formed of a positive electrode current collector and a positive electrode active material layer disposed on one surface thereof. The negative electrode plate is formed of a negative electrode current collector 5 and a negative electrode active material layer disposed on one surface thereof. The positive electrode plate and the negative electrode plate are positioned opposite to each other with the non-aqueous electrolyte solution of the present invention and a separator, which is provided in the non-aqueous electrolyte solution, disposed therebetween.

The positive electrode current collector and the negative electrode current collector may each be, for example, a metal foil made of a metal, such as aluminum, copper, nickel, or stainless steel.

Preferably, the positive electrode active material for use in the positive electrode active material layer is a lithium composite oxide. Examples of the lithium composite oxide include LiMnO₂, LiFeO₂, LiCoO₂, LiMn₂O₄, Li₂FeSiO₄, LiNi_{1/3}CO_{1/3}Mn_{1/3}O₂, and LiFePO₄.

The negative electrode active material for use in the negative electrode active material layer may be, for example, a material capable of occluding and releasing lithium. The material may be a carbon material or an oxide material. Examples of the carbon material include graphite and amorphous carbon. Examples of the oxide material include indium oxide, silicon oxide, tin oxide, zinc oxide, and lithium oxide.

The separator may be, for example, a porous film made of polyethylene, polypropylene, a fluororesin, or the like.

Examples of the energy storage device that includes the non-aqueous electrolyte solution of the present invention, a positive electrode, and a negative electrode include non-aqueous electrolyte secondary batteries and electric double layer capacitors. Preferred among these are lithium ion batteries and lithium ion capacitors.

Now, the present invention will be described in detail with reference to Examples, which are presented for illustrative purposes. That is, the Examples described below are not intended to be exhaustive or limit the present invention to the precise form described. Accordingly, the present invention is not limited to the Examples described below as long as the scope of the present invention is not exceeded. All parts and percentages are on a weight basis unless otherwise stated.

### EXAMPLES

### Example 1

A non-aqueous electrolyte solution was prepared as follows. Ethylene carbonate (EC) and diethyl carbonate (DEC) were mixed in a volume ratio of EC:DEC=30:70 to form a mixed non-aqueous solvent. LiPF₆, which was used as an electrolyte, was dissolved in the solvent in a concentration of 1.0 mol/L. 1,4,4a,9a-tetrahydroanthraquinone (THAQ), which was used as an additive for the non-aqueous electrolyte solution, was added in a proportion of 0.1 mass % based on a total weight of the solution formed of the mixed non-aqueous solvent and the electrolyte.

### Example 2

A non-aqueous electrolyte solution was prepared as in Example 1, except that 1,4,4a, 9a-tetrahydromethanoanthraquinone (CPNQ) was added in a proportion of 0.1 mass %, in place of 1,4,4a, 9a-tetrahydroanthraquinone (THAQ).

### Example 3

A non-aqueous electrolyte solution was prepared as in Example 1, except that 2-methyl-1,4,4a,9a-tetrahydroanthraquinone (MeTHAQ) was added in a proportion of 0.1 mass %, in place of 1,4,4a,9a-tetrahydroanthraquinone (THAQ).

(Example 4) A non-aqueous electrolyte solution was prepared as in Example 1, except that 2-(4-methyl-3-pentenyl)-1,4,4a, 9a-tetrahydroanthraquinone (IHETHAQ) was added in a proportion of 0.1 mass %, in place of 1,4,4a, 9a-tetrahydroanthraquinone (THAQ).

(Example 5) A non-aqueous electrolyte solution was prepared as in Example 1, except that 1,2,3,4,4a, 9a-hexahydrohexahydromethanoanthraquinone (NBNQ) was added in a proportion of 0.1 mass %, in place of 1,4,4a,9a-tetrahydroanthraquinone (THAQ).

### Comparative Example 1

A non-aqueous electrolyte solution was prepared as in Example 1, except that no 1,4,4a, 9a-tetrahydroanthraquinone (THAQ) was used.

### Comparative Example 2

A non-aqueous electrolyte solution was prepared as in Example 1, except that vinylene carbonate (VC) was added in a proportion of 0.1 mass %, in place of 1,4,4a,9a-tetrahydroanthraquinone (THAQ).

### Comparative Example 3

A non-aqueous electrolyte solution was prepared as in Example 1, except that ethyl acrylate (EA) was added in a proportion of 0.1 mass %, in place of 1,4,4a,9a-tetrahydroanthraquinone (THAQ).

### (Preparation of Coin-Cell-Type Lithium Ion Secondary Battery)

A commercially available electrode sheet coated with lithium cobalt oxide (manufactured by Hohsen Corp.) was used as a positive electrode sheet. A commercially available electrode sheet coated with graphite (manufactured by Hohsen Corp.) was used as a negative electrode sheet. A separator made of polypropylene was used as a separator. The positive electrode sheet, the negative electrode sheet, and the separator were punched to form respective circular sheets (positive electrode: 14 mmφ, negative electrode: 16 mmφ, separator: 18 mmφ). Coin-type lithium batteries were produced with a CR2032 coin cell kit (positive electrode case, negative electrode cap, spacer (1 mm thick), wave washer, and gasket) (manufactured by Hohsen Corp.), an aluminum micromesh used as a positive electrode current collector, and a copper micromesh used as a negative electrode current collector. Specifically, coin-cell-type lithium ion secondary batteries were produced as follows. The positive electrode current collector, the positive electrode sheet, the separator, and the gasket were stacked in the positive electrode case, and subsequently, each of the non-aqueous electrolyte solutions prepared in Examples 1 to 7 and Comparative Examples 1 to 3 was added thereto. Subsequently, the negative electrode sheet was placed so that the graphite-coated surface faced the positive-electrode-coated surface. Thereafter, the spacer, the wave washer, and the negative electrode cap were stacked on the negative electrode sheet, and the resultant was crimped with a coin cell crimper.

### (Measurement of Discharge Capacity Retention Rate)

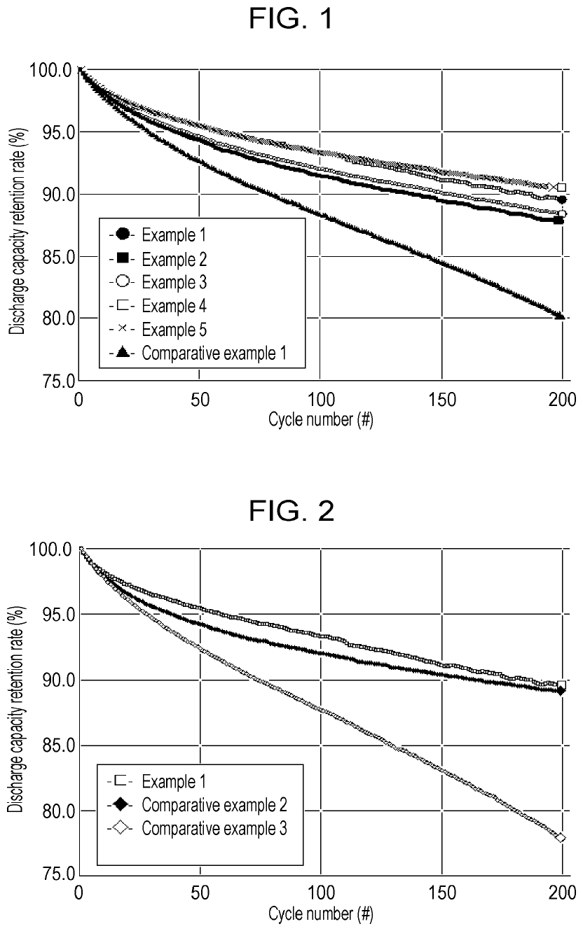

The produced coin-cell-type secondary batteries were subjected to three cycles of charging and discharging, which were performed at 25° C. with a charge rate of 0.2 C, a discharge rate of 0.2 C, a charge cutoff voltage of 4.2 V, and a discharge cutoff voltage of 3.0 V by using a charge-discharge test system (HJ1001 SD8) manufactured by Hokuto Denko Corporation and subsequently continuously subjected to 200 cycles of charging and discharging, which were performed at 25° C. with a charge rate of 1.0 C, a discharge rate of 1.0 C, a charge cutoff voltage of 4.2 V, and a discharge cutoff voltage of 3.0 V by using the charge-discharge test system. A discharge capacity of the 1st cycle and a discharge capacity retention rate (%) after 45 cycles were measured, and the results are shown in Tables 1 and 2. For Examples 1 to 5 and Comparative Examples 1 to 3, the discharge capacity retention rate (%) after 200 cycles was also measured, and the results are shown in Tables 1 and 2 and FIGS. 1 and 2. The “discharge capacity (mAh/g) of the 1st cycle” is a discharge capacity obtained by dividing the discharge capacity (mAh) of the 1st cycle of the 1.0 C charge-discharge test by the weight of the positive electrode active material of each of the cells. The “discharge capacity retention rate (%) after 200 cycles” is a rate obtained by dividing the discharge capacity (mAh/g) after 200 cycles of the 1.0 C charge-discharge test by the discharge capacity (mAh/g) after 1 cycle of the 1.0 C charge-discharge test and multiplying the result by 100. The “discharge capacity (%) after 45 cycles” was calculated in the same manner.

Table 1 shows the results of the measurements of the discharge capacity of the 1-C 1st cycle and the discharge capacity retention rates of the 45th cycle and the 200th cycle, regarding the instances in which a 4a,9a-dihydroanthraquinone compound or a 4a, 9a-dihydromethanoanthraquinone compound of the present invention was added to the nonaqueous electrolyte solution and the instance in which neither of the compounds was added. As is apparent from Table 1, the coin-cell-type secondary batteries that included the non-aqueous electrolyte solution containing a 4a, 9a-dihydroanthraquinone compound or a 4a, 9a-dihydromethanoanthraquinone compound of the present invention added thereto had higher discharge capacity retention rates of the 45th cycle and the 200th cycle than the coin-cell-type secondary battery that included a non-aqueous electrolyte solution to which the additive had not been added. In particular, in the instances where a 1,4,4a,9a-tetrahydroanthraquinone (THAQ) or 2-(4-methyl-3-pentenyl)-1,4,4a, 9a-tetrahydroanthraquinone (IHETHAQ) of the present invention was added, the discharge capacity retention rate of the 200th cycle was maintained at 90% or greater, which is a significant difference from that of the instance in which the additive was not added. The reason for these results is believed to be that an SEI film, which is stable against charge-discharge cycles, was formed on a surface of the electrodes of the non-aqueous electrolyte secondary batteries as a result of the addition of a 4a,9a-dihydroanthraquinone compound of the present invention to the non-aqueous electrolyte solution. It was also found that the coin-cell-type secondary batteries that included the non-aqueous electrolyte solution containing a 4a, 9a-dihydroanthraquinone compound or a 4a, 9a-dihydromethanoanthraquinone compound of the present invention added thereto all had a discharge capacity of the 1st cycle of the 1-C cycle test of 124 mAh or greater, which was higher than that of the coin-cell-type secondary battery that included a non-aqueous electrolyte solution to which the additive had not been added. Presumably, this indicates that the formed SEI film was thin and had low resistance and, therefore, did not impede the transfer of lithium ions. The results can be more clearly seen with reference to the graph of FIG. 1.

TABLE 1

| | | | | 45th | 200th |
|---|---|---|---|---|---|
| | | | 1st | Cycle | Cycle |
| | | | Cycle | Discharge | Discharge |
| | | Content of | Discharge | Capacity | Capacity |
| | | Additive | Capacity | Retention | Retention |
| | Additive | Wt % | mAh/g | Rate % | Rate % |
| Example 1 | THAQ | 0.1 | 125 | 96 | 90 |
| Example 2 | CPNQ | 0.1 | 126 | 95 | 88 |
| Example 3 | MeTHAQ | 0.1 | 125 | 95 | 88 |
| Example 4 | IHETHAQ | 0.1 | 124 | 96 | 90 |
| Example 5 | NBNQ | 0.1 | 123 | 96 | 90 |
| Compar- | No additive | | 123 | 93 | 80 |
| ative | | | | | |
| Example 1 | | | | | |

Table 2 shows an example of a comparison between 1,4,4a,9a-tetrahydroanthraquinone (THAQ) and compounds of the related art known to form an SEI film. In Example 1, 1,4,4a,9a-tetrahydroanthraquinone (THAQ) of the present invention was added, and in Comparative Example 2, vinylene carbonate (VC) was added. Vinylene carbonate is known to form an SEI film effective for the surface of the negative electrode as disclosed, for example, in Patent Document 1. As is apparent from Table 2, a comparison between Example 1 and Comparative Example 2 indicates that in the instance where 1,4,4a, 9a-tetrahydroanthraquinone (THAQ) of the present invention was added, the discharge capacity of the 1-C 1st cycle was higher, and the discharge capacity retention rates of the 45th cycle and the 200th cycle were maintained at a high level. Comparative Example 3 is an example in which ethyl acrylate (EA) was added. Ethyl acrylate is considered to prevent degradation of negative electrodes. A comparison with Comparative Example 3 also indicates that in the instance where 1,4,4a, 9a-tetrahydroanthraquinone (THAQ) of the present invention was added, the discharge capacity of the 1-C 1st cycle was clearly higher, and the discharge capacity retention rates of the 45th cycle and the 200th cycle were maintained at a very high level. The results can be more clearly seen with reference to the graph of FIG. 2.

TABLE 2

| | | | | 45th | 200th |
|---|---|---|---|---|---|
| | | | 1st | Cycle | Cycle |
| | | | Cycle | Discharge | Discharge |
| | | Content of | Discharge | Capacity | Capacity |
| | | Additive | Capacity | Retention | Retention |
| | Additive | Wt % | mAh/g | Rate % | Rate % |
| Example 1 | THAQ | 0.1 | 125 | 96 | 90 |
| Comparative | Vinylene | 0.1 | 124 | 95 | 89 |
| Example 2 | carbonate | | | | |
| Comparative | Ethyl | 0.1 | 122 | 84 | 78 |
| Example 3 | acrylate | | | | |

### INDUSTRIAL APPLICABILITY

Regarding a non-aqueous electrolyte solution for lithium ion secondary batteries and in lithium ion secondary batteries that use the non-aqueous electrolyte solution, using a non-aqueous electrolyte solution containing a 4a, 9a-dihydroanthraquinone compound or a 4a,9a-dihydromethanoanthraquinone compound of the present invention added thereto enables the production of an energy storage device having a high initial capacity, good cycle characteristics, and good rate characteristics, with the cycle characteristics including a capacity retention rate.

1. A non-aqueous electrolyte solution, comprising:
an electrolyte salt;
an organic solvent; and
a 4a,9a-dihydroanthraquinone compound of formula (1) or a 4a,9a-dihydromethanoanthraquinone compound of formula (2): 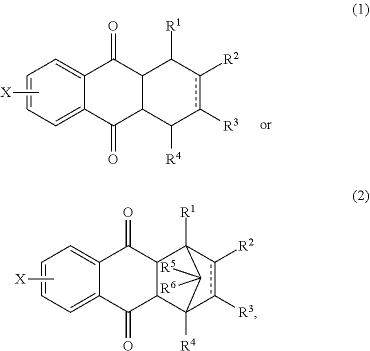
where R¹, R², R³, and R⁴ are independently H, a C₁ to C₁₀ alkyl group, a C₁ to C₁₀ alkenyl group, or a halogen atom,
X is H, a C₁ to C₁₀ alkyl group, or a halogen atom, and
a portion in which solid and dashed parallel lines are drawn is a single bond or a double bond.

2. The non-aqueous electrolyte solution of claim 1, wherein the organic solvent comprises a cyclic carbonate, chain carbonate, aliphatic carboxylic acid ester, lactone, lactam, cyclic ether, chain ether, sulfone, halogen derivative thereof, or mixture of two or more of any of these.

3. The non-aqueous electrolyte solution of claim 1, wherein the electrolyte salt is a lithium salt.

4. An energy storage device, comprising:
the non*aqueous electrolyte solution of claim 1;
a positive electrode; and
a negative electrode.

5. An energy storage device, comprising:
the non-aqueous electrolyte solution of claim 3;
a positive electrode; and
a negative electrode.

6. The device of claim 4, which is a lithium ion battery.

7. The device of claim 5, which is a lithium ion battery.

8. The non-aqueous electrolyte solution of claim 2, wherein the electrolyte salt is a lithium salt.

9. The non-aqueous electrolyte solution of claim 1, comprising the 4a,9a-dihydroanthraquinone compound of formula (1).

10. The non-aqueous electrolyte solution of claim 1, comprising the 4a,9a-dihydromethanoanthraquinone compound of formula (2).

11. The non-aqueous electrolyte solution of claim 1, wherein the 4a, 9a-dihydroanthraquinone compound of formula (1) is present and comprises
2-methyl-1,4,4a,9a-tetrahydroanthraquinone,
1-methyl-1,4,4a,9a-tetrahydroanthraquinone,
2-ethyl-1,4,4a,9a-tetrahydroanthraquinone,
2-butyl-1,4,4a,9a-tetrahydroanthraquinone,
2-amyl-1,4,4a,9a-tetrahydroanthraquinone,
1,3-dimethyl-1,4,4a,9a-tetrahydroanthraquinone,
2,3-dimethyl-1,4,4a, 9a-tetrahydroanthraquinone,
1,4-dimethyl-1,4,4a,9a-tetrahydroanthraquinone,
2-chloro-1,4,4a,9a-tetrahydroanthraquinone, and/or
2-bromo-1,4,4a,9a-tetrahydroanthraquinone.

12. The non-aqueous electrolyte solution of claim 1, wherein the 4a,9a-dihydroanthraquinone compound of formula (1) is present and comprises
1,2,3,4,4a,9a-hexahydroanthraquinone,
2-methyl-1,2,3,4,4a,9a-hexahydroanthraquinone,
1-methyl-1,2,3,4,4a,9a-hexahydroanthraquinone,
2-ethyl-1,2,3,4,4a,9a-hexahydroanthraquinone,
2-butyl-1,2,3,4,4a,9a-hexahydroanthraquinone,
2-amyl-1,2,3,4,4a,9a-hexahydroanthraquinone,
1,3-dimethyl-1,2,3,4,4a,9a-hexahydroanthraquinone,
2,3-dimethyl-1,2,3,4,4a, 9a-hexahydroanthraquinone,
1,4-dimethyl-1,2,3,4,4a,9a-hexahydroanthraquinone,
2-chloro-1,2,3,4,4a,9a-hexahydroanthraquinone, and/or
2-bromo-1,2,3,4,4a,9a-hexahydroanthraquinone.

13. The non-aqueous electrolyte solution of claim 1, wherein the 4a,9a-dihydroanthraquinone compound of formula (1) is present and comprises
6-methyl-1,4,4a,9a-tetrahydroanthraquinone,
2,6-dimethyl-1,4,4a,9a-tetrahydroanthraquinone,
2,7-dimethyl-1,4,4a,9a-tetrahydroanthraquinone,
2-ethyl-6-methyl-1,4,4a,9a-tetrahydroanthraquinone,
2-butyl-6-methyl-1,4,4a,9a-tetrahydroanthraquinone,
2-amyl-6-methyl-1,4,4a,9a-tetrahydroanthraquinone,
2-chloro-6-methyl-1,4,4a,9a-tetrahydroanthraquinone,
2-bromo-6-methyl-1,4,4a,9a-tetrahydroanthraquinone,
6-methyl-1,2,3,4,4a,9a-hexahydroanthraquinone,
2,6-dimethyl-1,2,3,4,4a, 9a-hexahydroanthraquinone,
2,7-dimethyl-1,2,3,4,4a,9a-hexahydroanthraquinone,
2-ethyl-6-methyl-1,2,3,4,4a,9a-hexahydroanthraquinone,
2-butyl-6-methyl-1,2,3,4,4a,9a-hexahydroanthraquinone,
2-amyl-6-methyl-1,2,3,4,4a,9a-hexahydroanthraquinone,
2-chloro-6-methyl-1,2,3,4,4a,9a-hexahydroanthraquinone, and/or
2-bromo-6-methyl-1,2,3,4,4a,9a-hexahydroanthraquinone.

14. The non-aqueous electrolyte solution of claim 1, wherein the 4a,9a-dihydroanthraquinone compound of formula (1) is present and comprises
6-chloro-1,4,4a,9a-tetrahydroanthraquinone,
2-methyl-6-chloro-1,4,4a,9a-tetrahydroanthraquinone,
2-ethyl-6-chloro-1,4,4a,9a-tetrahydroanthraquinone,
2-butyl-6-chloro-1,4,4a,9a-tetrahydroanthraquinone,
2-amyl-6-chloro-1,4,4a,9a-tetrahydroanthraquinone,
2,6-dichloro-1,4,4a,9a-tetrahydroanthraquinone,
2-bromo-6-chloro-1,4,4a,9a-tetrahydroanthraquinone,
6-chloro-1,2,3,4,4a,9a-hexahydroanthraquinone,
2-methyl-6-chloro-1,2,3,4,4a,9a-hexahydroanthraquinone,
2-ethyl-6-chloro-1,2,3,4,4a,9a-hexahydroanthraquinone,
2-butyl-6-chloro-1,2,3,4,4a,9a-hexahydroanthraquinone,
2-amyl-6-chloro-1,2,3,4,4a,9a-hexahydroanthraquinone,
2,6-dichloro-1,2,3,4,4a,9a-hexahydroanthraquinone, and/or
2-bromo-6-chloro-1,2,3,4,4a,9a-hexahydroanthraquinone.

15. The non-aqueous electrolyte solution of claim 1, wherein the 4a,9a-dihydroanthraquinone compound of formula (1) is present and comprises
1-(2-methyl-2-butenyl)-3-methyl-1,4,4a,9a-tetrahydroanthraquinone,
1-(3-butenyl)-1,4,4a,9a-tetrahydroanthraquinone,
2-(4-methyl-3-pentenyl)-1,4,4a,9a-tetrahydroanthraquinone, and/or
1-(2-methyl-1-propenyl)-3,4-dimethyl-1,4,4a,9a-tetrahydroanthraquinone.

16. The non-aqueous electrolyte solution of claim 1, wherein the 4a, 9a-dihydromethanoanthraquinone compounds of formula (2) is present and comprises
1,4,4a,9a-tetrahydromethanoanthraquinone,
1-methyl-1,4,4a,9a-tetrahydromethanoanthraquinone,
2-methyl-1,4,4a,9a-tetrahydromethanoanthraquinone,
11-methyl-1,4,4a,9a-tetrahydromethanoanthraquinone,
11,11-dimethyl-1,4,4a,9a-tetrahydromethanoanthraquinone,
1,2,3,4,11-pentamethyl-1,4,4a,9a-tetrahydromethanoanthraquinone,
6-methyl-1,4,4a,9a-tetrahydromethanoanthraquinone,
6-ethyl-1,4,4a,9a-tetrahydromethanoanthraquinone,
1,6-dimethyl-1,4,4a,9a-tetrahydromethanoanthraquinone,
2,6-dimethyl-1,4,4a, 9a-tetrahydromethanoanthraquinone,
6,11-dimethyl-1,4,4a,9a-tetrahydromethanoanthraquinone,
6,11,11-trimethyl-1,4,4a,9a-tetrahydromethanoanthraquinone,
6-chloro-1,4,4a,9a-tetrahydromethanoanthraquinone,
6-bromo-1,4,4a,9a-tetrahydromethanoanthraquinone,
1,2,3,4,4a,9a-hexahydromethanoanthraquinone,
1-methyl-1,2,3,4,4a,9a-hexahydromethanoanthraquinone,
2-methyl-1,2,3,4,4a,9a-hexahydromethanoanthraquinone,
11-methyl-1,2,3,4,4a,9a-hexahydromethanoanthraquinone,
11,11-dimethyl-1,2,3,4,4a,9a-hexahydromethanoanthraquinone,
1,2,3,4,11-pentamethyl-1,2,3,4,4a,9a-hexahydromethanoanthraquinone,
6-methyl-1,2,3,4,4a,9a-hexahydromethanoanthraquinone,
6-ethyl-1,2,3,4,4a,9a-hexahydromethanoanthraquinone,
1,6-dimethyl-1,2,3,4,4a,9a-hexahydromethanoanthraquinone,
2,6-dimethyl-1,2,3,4,4a,9a-hexahydromethanoanthraquinone,
6,11-dimethyl-1,2,3,4,4a,9a-hexahydromethanoanthraquinone,
6,11,11-trimethyl-1,2,3,4,4a,9a-hexahydromethanoanthraquinone,
6-chloro-1,2,3,4,4a,9a-hexahydromethanoanthraquinone, and/or
6-bromo-1,2,3,4,4a,9a-hexahydromethanoanthraquinone.

17. The non-aqueous electrolyte solution of claim 1, comprising
1,4,4a,9a-tetrahydroanthraquinone,
1,4,4a,9a-tetrahydromethanoanthraquinone,
2-methyl-1,4,4a,9a-tetrahydroanthraquinone,
2-(4-methyl-3-pentenyl)-1,4,4a,9a-tetrahydroanthraquinone, and/or
1,2,3,4,4a,9a-hexahydrohexahydromethanoanthraquinone.

18. The non-aqueous electrolyte solution of claim 1, wherein the organic solvent comprises a cyclic carbonate and/or a chain carbonate.
